(19) United States
(12) Patent Application Publication
(10) Pub. No.: US 2025/0202143 A1
(43) Pub. Date: Jun. 19, 2025

(54) ELECTRICAL CONNECTOR ASSEMBLY AND POWER SYSTEM

(71) Applicant: BELLWETHER ELECTRONIC CORP., Taoyuan City (TW)

(72) Inventor: FAN-HSUAN LIU, Taoyuan City (TW)

(21) Appl. No.: 18/945,546

(22) Filed: Nov. 13, 2024

Related U.S. Application Data
(60) Provisional application No. 63/612,061, filed on Dec. 19, 2023.

(51) Int. Cl. H01R 12/72; H01R 12/75

(52) U.S. Cl. CPC H01R 12/722; H01R 12/75

(57) ABSTRACT

An electrical connector assembly and a power system are provided. The electrical connector includes a forwarding connector that is mounted on a circuit board. The forwarding connector includes a first insulative housing, a forwarding socket, and a plurality of first power terminals. The first insulative housing includes a first lateral surface and a second lateral surface that face different orientations. The first lateral surface has a first slot. The forwarding socket is disposed on the second lateral surface. Each of the first power terminals includes at least one first elastic arm and a first connecting arm. The first elastic arms are disposed in the first slot. The plurality of first connecting arms are disposed in the forwarding socket. The plurality of first power terminals are not physically connected with the circuit board.

### CROSS-REFERENCE TO RELATED PATENT APPLICATION

This application claims the benefit of priority to the U.S. Provisional Patent Application Ser. No. 63/612,061 filed on Dec. 19, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electrical connector assembly and a power system, and more particularly to an electrical connector assembly and a power system capable of shunting power and signals.

### BACKGROUND OF THE DISCLOSURE

Generally, electrical connectors are used to transmit power and signals. For example, when a board end connector is connected to a circuit board, power and signals are transmitted to the circuit board through the board end connector, and then from the circuit board to other components, such as server racks or hosts. However, the conductive metal layer, such as a copper layer, that is covered on the surface of the circuit board has a limited area and thickness. As a result, the impedance of the conductive metal layer of the circuit board is too high, which can cause overheating when large currents are transmitted.

Therefore, how to overcome the above-mentioned problem through an improvement in structural design has become an important issue to be addressed in the related art.

### SUMMARY OF THE DISCLOSURE

In response to the above-referenced technical inadequacy, the present disclosure provides an electrical connector assembly and a power system, which can address an issue of the circuit board overheating due to high impedance when currents flow through the circuit board.

In order to solve the above-mentioned problems, one of the technical aspects adopted by the present disclosure is to provide an electrical connector assembly, which includes a forwarding connector that is mounted on a circuit board. The forwarding connector includes a first insulative housing, a forwarding socket, and a plurality of first power terminals. The first insulative housing includes a first lateral surface and a second lateral surface that face different orientations. The first lateral surface has a first slot. The forwarding socket are disposed on the second lateral surface. Each of the first power terminals includes at least one first elastic arm and a first connecting arm. The plurality of first elastic arms of the first power terminals are disposed in the first slot to form an input interface for being inserted into by an electronic card that is used to provide power. The plurality of first connecting arms of the first power terminals are disposed in the forwarding socket to form a power output surface. The plurality of first power terminals are not physically connected with the circuit board.

In order to solve the above-mentioned problems, another one of the technical aspects adopted by the present disclosure is to provide a power system, which includes a forwarding connector, a mating connector, and a circuit board. The mating connector is adapted to the forwarding connector. The mating connector is detachably plugged into the forwarding socket. The forwarding connector includes a first insulative housing, a forwarding socket, and a plurality of first power terminals. The first insulative housing includes a first lateral surface and a second lateral surface that face different orientations. The first lateral surface has a first slot. The forwarding socket is disposed on the second lateral surface. Each of the first power terminals includes a first elastic arm and a first connecting arm. The plurality of first elastic arms of the first power terminals are disposed in the first slot to form an input interface for being inserted into by an electronic card that is used to provide power. The plurality of first connecting arms of the first power terminals are disposed in the forwarding socket to form a power output surface. The mating connector includes a second insulative housing, a plurality of second power terminals, and a plurality of power wires. The plurality of power wires are electrically connected to the circuit board. When the electronic card is inserted into the input interface, currents provided by the electronic card are transmitted to the circuit board through the forwarding connector and the mating connector.

Therefore, in the electrical connector assembly and the power system provided by the present disclosure, by virtue of “the first insulative housing including a first lateral surface and a second lateral surface that face different orientations,” “the plurality of first elastic arms being disposed in the first slot to form an input interface,” and “the plurality of first connecting arms being disposed in the forwarding socket to form a power output surface,” the input interface and the power output interface face different directions, thereby shunting power and signals provided by the electronic card to different paths. Power is transmitted through the wire end connector that is mated with the socket of the connector, which prevents large currents from flowing through the circuit board and causing overheating.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a first schematic view of an electrical connector assembly according to a first embodiment of the present disclosure;

FIG. 2 is a second schematic view of the electrical connector assembly according to the first embodiment of the present disclosure;

FIG. 3 is a schematic exploded view of the electrical connector assembly according to the first embodiment of the present disclosure;

FIG. 4 is a first schematic view of a forwarding connector according to the first embodiment of the present disclosure;

FIG. 5 is a second schematic view of the forwarding connector according to the first embodiment of the present disclosure;

FIG. 6 is a schematic exploded view of the forwarding connector and an electronic card according to the first embodiment of the present disclosure;

FIG. 7 is a schematic view of first power terminals according to the first embodiment of the present disclosure;

FIG. 8 is a schematic view of signal terminals according to the first embodiment of the present disclosure;

FIG. 9 is a schematic view of a mating connector according to the first embodiment of the present disclosure;

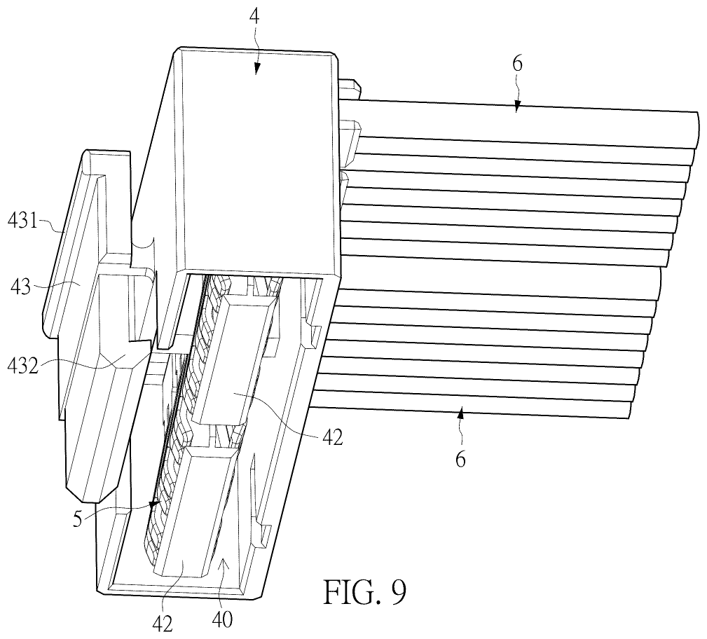

FIG. 10 is a schematic view of second power terminals according to the first embodiment of the present disclosure;

FIG. 11 is a schematic cross-sectional view taken along line XI-XI of FIG. 1;

FIG. 12 a first schematic view of an electrical connector assembly according to a second embodiment of the present disclosure;

FIG. 13 is a partial schematic exploded view of the electrical connector assembly according to the second embodiment of the present disclosure;

FIG. 14 is a schematic view of a forwarding connector and a mating connector according to the second embodiment of the present disclosure;

FIG. 15 is a schematic view of first power terminals according to the second embodiment of the present disclosure;

FIG. 16 is a schematic view of the mating connector according to the second embodiment of the present disclosure;

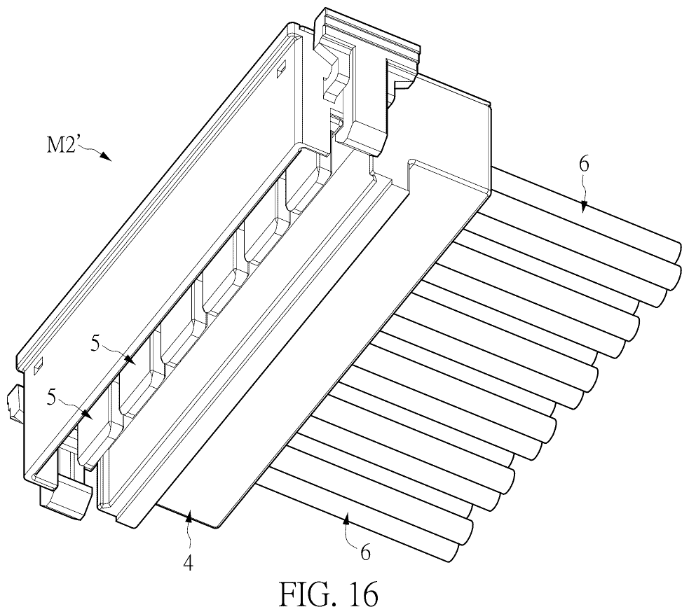

FIG. 17 is a schematic view of second power terminals according to the second embodiment of the present disclosure; and

FIG. 18 is a schematic cross-sectional view taken along line XVIII-XVIII of FIG. 12.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

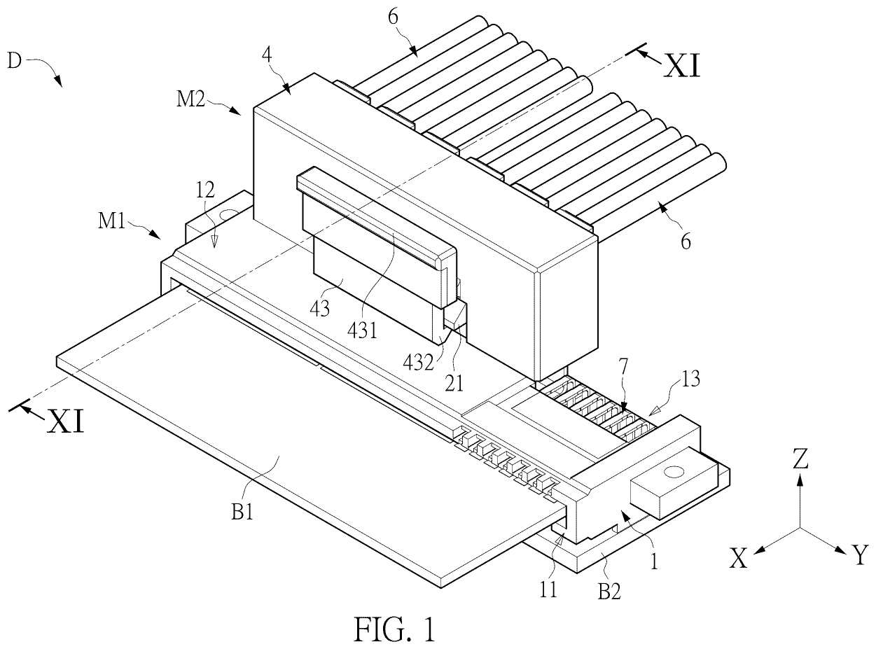

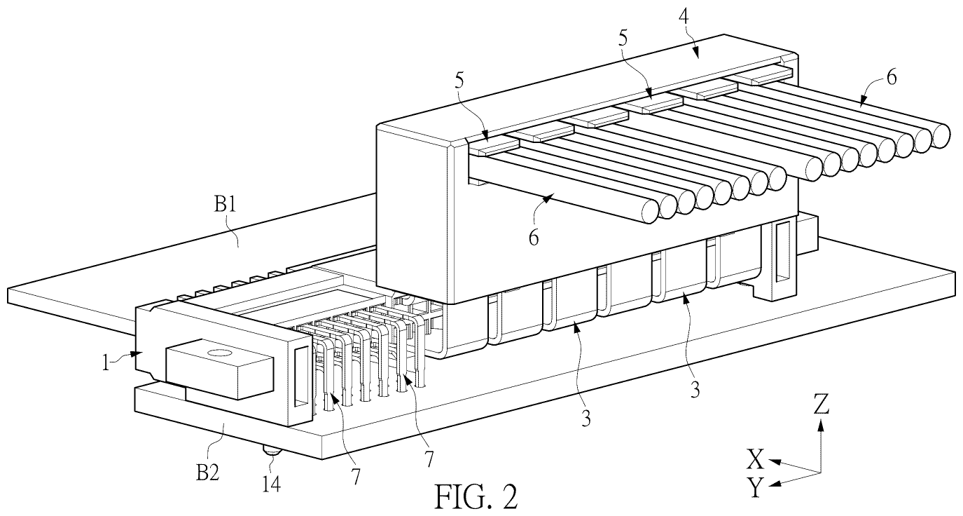

Reference is made to FIG. 1 to FIG. 3. A first embodiment of the present disclosure provides an electrical connector assembly D, which includes a forwarding connector M1 and a mating connector M2. For example, the forwarding connector M1 can be a connector that is mounted on a board, and the mating connector M2 can be a wire end connector. The forwarding connector M1 is used for being inserted into by an electronic card B1. The mating connector M2 is disposed on a circuit board B2. The electronic card B1 is used to provide power. Alternatively, the electronic card B1 is used to provide power and signals. The power does not pass through the circuit board B2 but is output to other components (not shown in the figures) through the forwarding connector M1 and the mating connector M2. Furthermore, the signals are transmitted to the circuit board B2 through the forwarding connector M1.

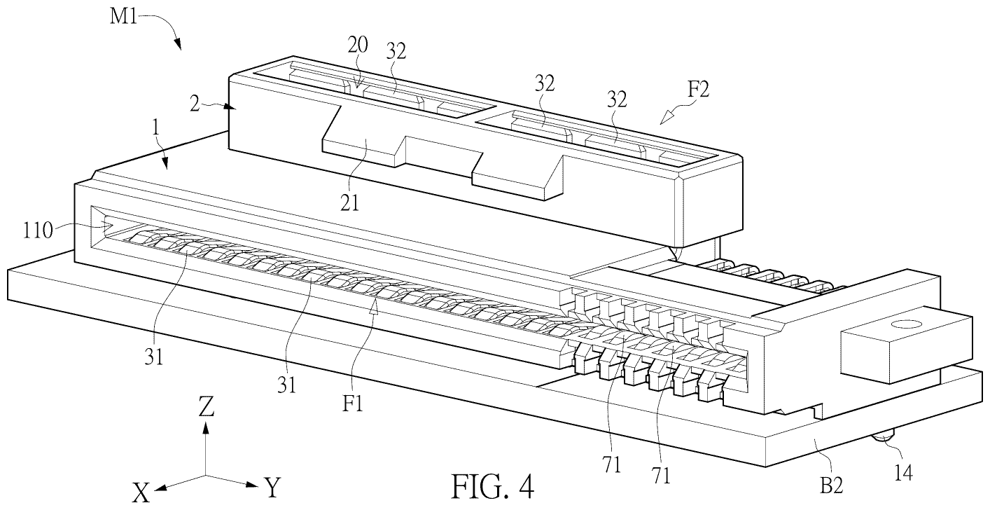

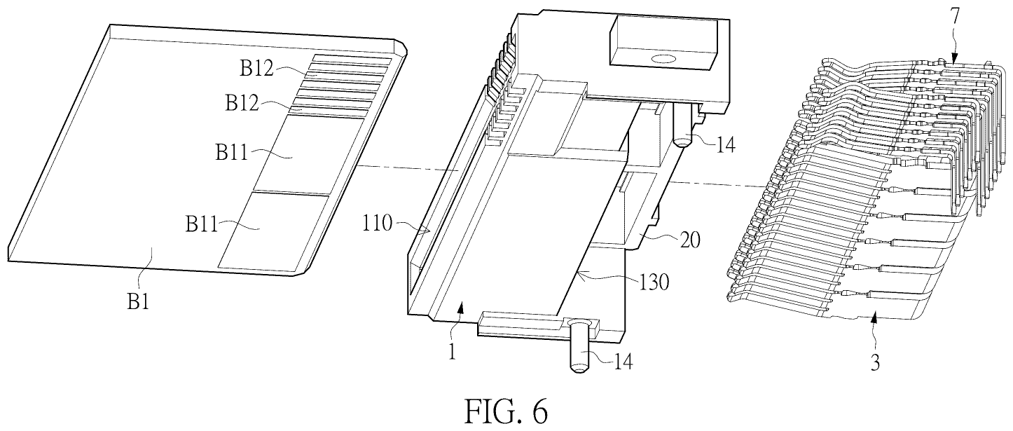

Reference is made to FIG. 4 to FIG. 6. The forwarding connector M1 includes a first insulative housing 1, a forwarding socket 2, and a plurality of first power terminals 3. The mating connector M2 is detachably plugged into the forwarding socket 2. The first insulative housing 1 including a first lateral surface 11, a second lateral surface 13, and a third surface 12 that face different orientations. As shown in FIG. 6, the first lateral surface 11 has a first slot 110, and the second lateral surface 13 has a second slot 130. The first slot 110 and the second slot 130 are interconnected with each other. The forwarding socket 2 is disposed on or adjacent to the second slot 130. The plurality of first power terminals 3 are inserted into the first insulative housing 1 from the second slot 130. Moreover, the first insulative housing 1 further includes a plurality of fixing posts 14, and the first insulative housing 1 is fixed (in position) by inserting the plurality of fixing posts 14 on the circuit board B2.

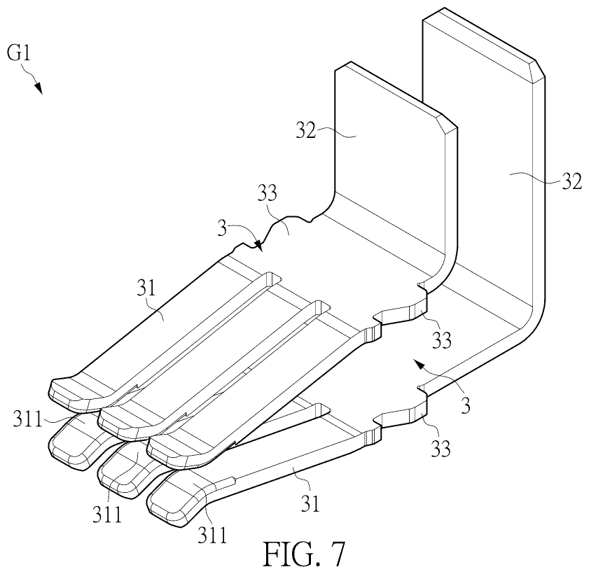

Reference is made to FIG. 6 and FIG. 7. The plurality of first power terminals 3 are divided into a plurality of first terminal sets G1. Each of the first terminal sets G1 includes two of the first power terminals 3 that are opposite to each other. The two first power terminals 3 are spaced apart from and not in contact with each other, such as to transmit the power with the same or different electric potentials. Each of the first power terminals 3 includes at least one first elastic arm 31 and a first connecting arm 32. The first elastic arm 31 includes a first contact portion 311. The first contact portion 311 is located an inner surface of the at least one first elastic arm 31. The first connecting arm 32 is flat-shaped and located in the forwarding socket 2 to abut against or adjacent to an inner surface of the forwarding socket 2. In each of the first terminal sets G1, the two first contact portions 311 of the two first power terminals 3 are arranged to face each other. Moreover, each of the first power terminals 3 forms a bent shape. There is an included angle between the at least one first elastic arm 31 and the first connecting arm 32, and the included angle is less than 180 degrees. Preferably, the at least one first elastic arm 31 is bent inwardly toward the first contact portion 311 to form a bending point, which is a connection point between the at least one first elastic arm 31 and the first connecting arm 32. In other words, in each of the first terminal sets G1, the first elastic arm 31 of one of the first power terminals 3 is bent toward another first elastic arm 31 of the other of the first power terminals 3.

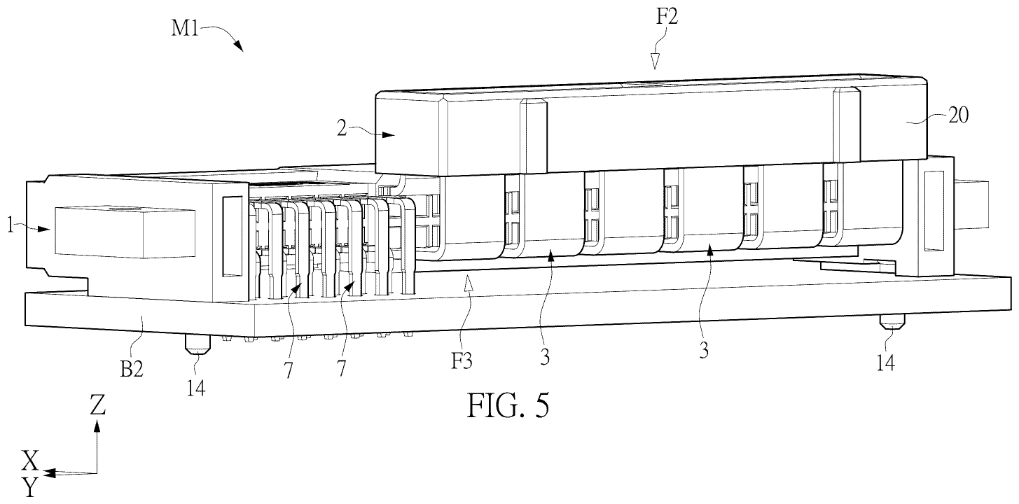

Reference is made to FIG. 4 and FIG. 5. The first elastic arms 31 of the plurality of first power terminals 3 extend into the first slot 110. The first connecting arms 32 of the plurality of first power terminals 3 extend from the second slot 130 and are bent upward, for example, 90 degrees, into the forwarding socket 2. That is, the plurality of first power terminals 3 are not in physical contact with the circuit board B2. The plurality of first elastic arms 31 are disposed in the first slot 110 to form an input interface F1 for being inserted into by the electronic card B1. The plurality of first connecting arms 32 of the first power terminals 3 extend out of the second slot 130 and are disposed in the forwarding socket 2 to form a power output surface F2. Therefore, the power provided by the electronic card B1 is input from the input interface F1, and is output from the power output surface F2 by the plurality of first power terminals 3.

Reference is made to FIGS. 1, 6, and 11. When the electronic card B1 is inserted into the first slot 110, the two first elastic arms 31 of the two first power terminals 3 of each of the first terminal sets G1 clamp the electronic card B1, and the two first contact portions 311 of the two first elastic arms 31 are in contact with at least two power transmission pads B11 on upper and lower surfaces of the electronic card B1. It should be noted that only the power transmission pads B11 that are located on the lower surface of the electronic card B1 are shown in FIG. 6 because of the limited angle.

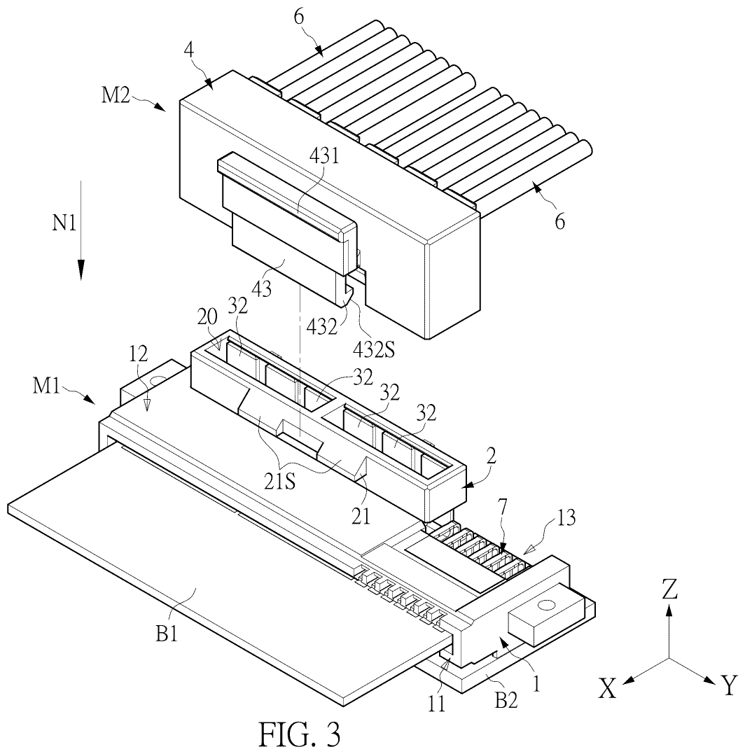

Reference is made to FIGS. 3, 4, and 10. The mating connector M2 includes a second insulative housing 4, a plurality of second power terminals 5, and a plurality of power wires 6. The plurality of second power terminals 5 are disposed in the second insulative housing 4. The plurality of power wires 6 extend into the second insulative housing 4 and are electrically connected to the plurality of second power terminals 5. When the mating connector M2 is plugged into the forwarding socket 2 of the forwarding connector M1, the plurality of second power terminals 5 are electrically connected to the plurality of first power terminals 3, respectively, so as to transmit power from the power output surface F2 to the plurality of power wires 6.

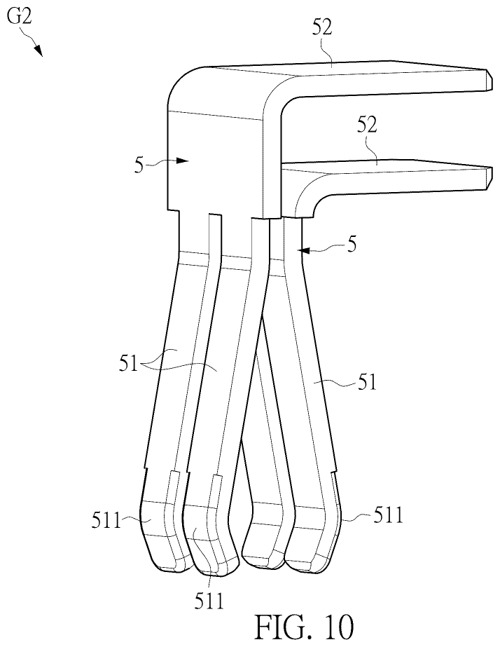

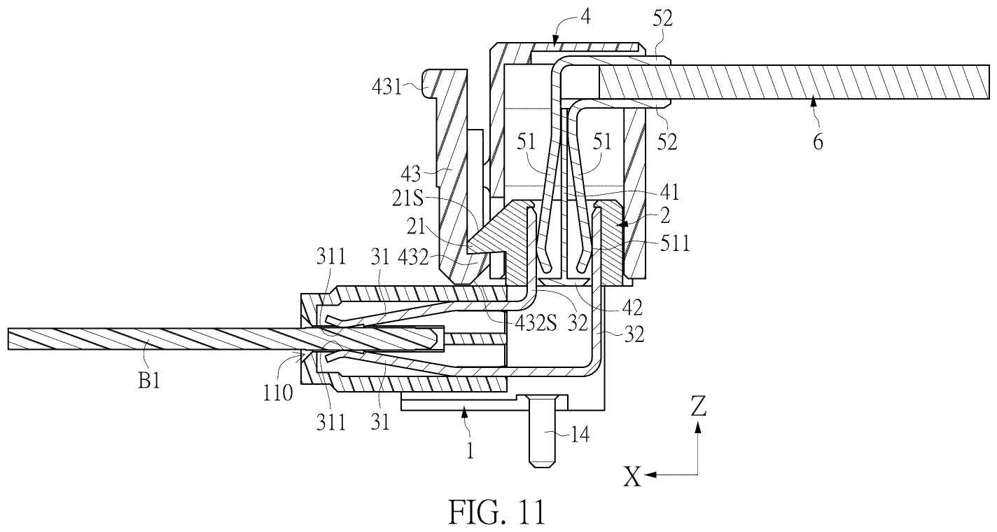

Reference is made to FIGS. 10 and 11. The plurality of second power terminals 5 are divided into at least one second terminal set G2. Each of the second terminal sets G2 includes two of the second power terminals 5 that are opposite to each other. The two second power terminals 5 are spaced apart from and not in contact with each other, such as to transmit power with the same or different electric potentials. Each of the second power terminals 5 includes at least one second contact arm 51 and a second connecting arm 52. The second connecting arm 51 is flat-shaped and electrically connected to the plurality of power wires 6. For example, the second connecting arm 52 of each of the second power terminals 5 is connected to at least one of the power wires 6 by ultrasonic welding. The at least one second contact arm 51 is an elastic arm. The at least one second contact arm 51 includes a second contact portion 511, and the second contact portion 511 is located on an outer surface of the at least one second contact arm 51. As shown in FIG. 10, in each of the second terminal sets G2, the two second contact portions 511 of the two second power terminals 5 are arranged in a back-to-back configuration. Each of the second power terminals 5 forms a bent shape. There is an included angle of about 90 degrees between the at least one second contact arm 51 and the second connecting arm 52. As shown in FIG. 11, through the structural design of bending the first power terminals 3 and the second power terminals 5, an inserting direction (i.e., a power input direction) of the electronic card B1 can be parallel to but not on the same plane as an extending direction (i.e., the power output direction) of the power wires 6.

Reference is made to FIG. 11. The second insulative housing 4 includes a partition wall 41 and a stopping portion 42 inside. The partition wall 41 is disposed between the two second contact arms 51, and the stopping portion 42 is connected to a bottom of the partition wall 41. When the mating connector M2 is plugged into the forwarding socket 2 of the forwarding connector M1, a docking slot 40 at a bottom of the second insulative housing 4 is docked with a forwarding slot 20 of the forwarding socket 2, and the two second contact arms 51 of the two second power terminals 5 of each of the second terminal sets G2 are located between the two first connecting arms 32 of the two first power terminals 3 of a corresponding one of the first terminal sets G1. In other words, the two second contact arms 51 are sandwiched between the two first connecting arms 32. The two second contact arms 51 provide an elastic force to abut the two first connecting arms 32, respectively, such that the two first connecting arms 32 physically contact the two second contact arms 51, respectively, thereby resulting in an electrical connection between the first power terminals 3 and the second power terminals 5. In addition, through the structural design of the stopping portion 42, the second contact arms 51 can be protected by the stopping portion 42 to prevent the second contact arms 51 from being improperly hit by other objects. Furthermore, the stopping portion 42 prevents the first connecting arms 32 from directly colliding with the second contact arms 51 during the plugging process by being inserted in an incorrect plugging direction, causing the second contact arms 51 to bend or shift, thereby affecting the current conduction efficiency.

In the present disclosure, the electrical connection between one of the first power terminals 3 and the corresponding one of the second power terminals 5 is achieved by the elastic arm of the second power terminal 5 abutting against the flat connecting arm of the first power terminal 3. The elastic arm provides a normal force on the flat connecting arm, such that the physical contact between the elastic arm and the flat connecting arm is strong enough, and the contact area between the elastic arm and the flat connecting arm is large enough to reduce the contact impedance during current transmission. The configuration of the elastic arm and the flat connecting arm is not limited in the present disclosure. For example, in another embodiment, the elastic arm (i.e., the second contact arm 51) of the second power terminal 5 can be replaced with the flat connecting arm, and the flat connecting arm (i.e., the first connecting arm 31) of the first power terminal 3 can be replaced with the elastic arm.

Reference is made to FIGS. 3 and 11. The second insulative housing 4 further includes a latching member 43. The latching member 43 is disposed on the second insulative housing 4 and is arranged opposite to the plurality of power wires 6. The second insulative housing 4 is a rectangular cuboid, and the latching member 43 is disposed at a long side of rectangular cuboid. As shown in FIG. 3 and FIG. 11, the latching member 43 includes a button portion 431 and a hook portion 432 which has a guiding surface 432S. The forwarding socket 2 includes a protruding portion 21 which has a guiding surface 21S. A slope of the guiding surface 432S is the same as a slope of the guiding surface 21S. When the mating connector M2 is plugged into the forwarding socket 2 of the forwarding connector M1 along a direction N1, the guiding surface 432S of the hook portion 432 abuts against the guiding surface 21S of the protruding portion 21 and moves relative to each other, such that the hook portion 432 can be smoothly snapped to the protruding portion 21 through the two guiding surfaces 432S and 21S, so as to fix the mating connector M2 with the forwarding connector M1. On the other hand, when the mating connector M2 is departed from the forwarding socket 2, an user only needs to press the button portion 431 of the latching member 43 to separate the hook portion 432 from the protruding portion 21 and pick the mating connector M2 up, thereby allowing the mating connector M2 to be removed from the forwarding socket 2.

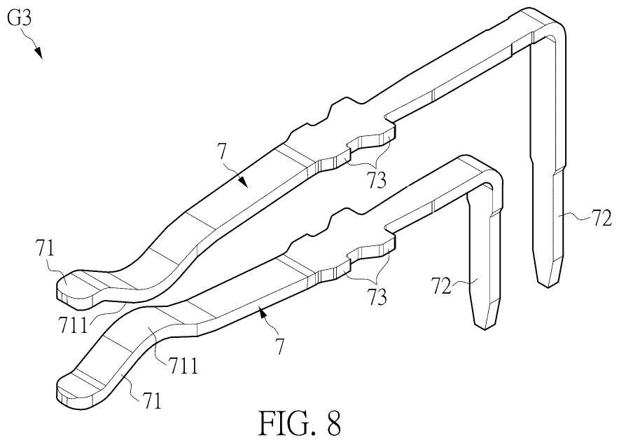

Reference is made to FIG. 4 to FIG. 6, and in conjunction with FIG. 8. The forwarding connector M1 further includes a plurality of signal terminals 7 that are disposed in the first insulative housing 1. Each of the signal terminals 7 includes an elastic arm 71 and a pin 72. Each of the signal terminals 7 forms a bent shape, and there is an included angle of about 90 degrees between the elastic arm 71 and the pin 72. The elastic arms 71 of the plurality of signal terminals 7 are disposed in the first slot 110. Two of the elastic arms 71 are in contact with two signal transmission pads B12 on opposite surfaces of the electronic card B1 that is inserted into the first slot 110. The pins 72 of the plurality of signal terminals 7 extend out of the second slot 130 and are bent to be installed with the circuit board B2, so as to form a signal output surface F3. As shown in FIGS. 4 and 5, the signals provided by the electronic card B1 are input from the input interface F1, and are completely output from the signal output interface F3 to the circuit board B2 by the plurality of signal terminals 7. In the present disclosure, through the input interface F1, the power output surface F2, and the signal output surface F3 facing different orientations, the power and signals provided by the electronic card B1 is shunted and transmitted to different paths. The power is transmitted through the power wires 6 of the mating connector M2 to another side of the circuit board B2 or another circuit board (not shown in the figures) to prevent large currents from flowing through the circuit board B2 and causing overheating. The signals are transmitted through the circuit board B2.

In addition, as shown in FIG. 7, each of the first power terminals 3 further includes an interference portion 33. The interference portion 33 is disposed between the first elastic arm 31 and the first connecting arm 32. As shown in FIG. 8, each of signal terminals 7 further includes an interference portion 73. The interference portion 73 is disposed between the elastic arm 71 and the pin 72. Through the structural design of the interference portions 33 and 73, the first power terminals 3 and the signal terminals 7 are fixed in the first insulative housing 1 without being displaced because of the insertion and removal of the electronic card B1.

In the present disclosure, the forwarding connector M1 includes the plurality of first power terminals 3 and the plurality of signal terminals 7. However, the aforementioned description for the forwarding connector M1 of the first embodiment is merely an example, and is not meant to limit the scope of the present disclosure. In another embodiment, the forwarding connector M1 can include the first power terminals 3 but not the signal terminals 7. In other words, the forwarding connector M1 is not limited to a connector that is disposed on the circuit board B2, but can be disposed on any position to cooperate with any electronic device that requires the transmission of large currents. The forwarding connector M1 is installed at any position in the electronic device and transmits current to one or more circuit boards or other electronic components in the electronic device through the power wires 6 of the mating connector M2. In addition to preventing the circuit board B2 from overheating, the circuit board B2 can further save space for installing the forwarding connector M1, thereby reducing the area and cost of the circuit board B2.

### Second Embodiment

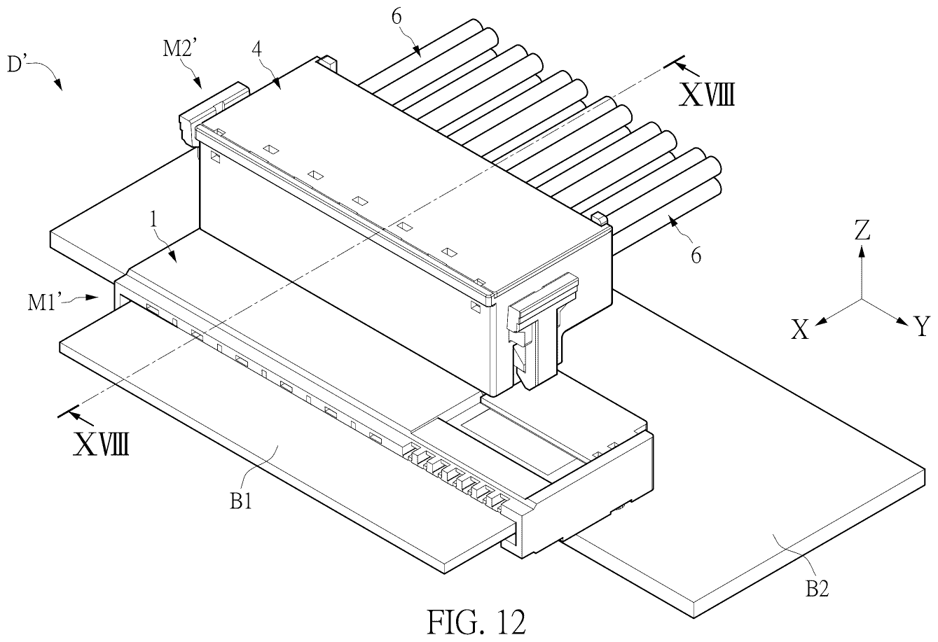

Reference is made to FIG. 12. A second embodiment of the present disclosure provides an electrical connector assembly D′. The structure of the electrical connector assembly D′ is similar to that of the electrical connector assembly D of the first embodiment. The electrical connector assembly D′ includes a forwarding connector M1′ and a mating connector M2′. The forwarding connector M1′ is used for being inserted into by an electronic card B1. The forwarding connector M1′ is disposed on a circuit board B2.

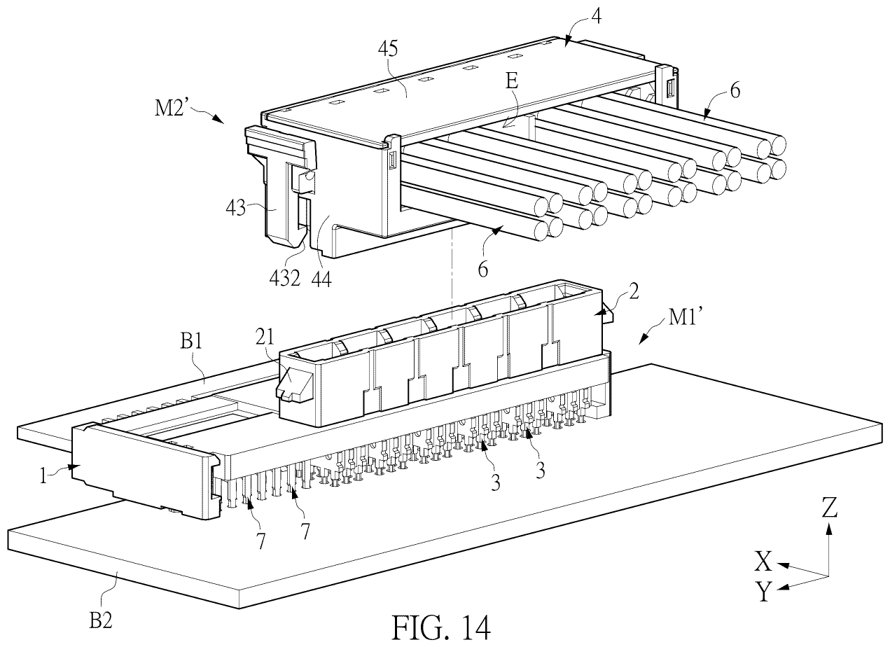

Reference is made to FIG. 14. The forwarding connector M1′ includes a first insulative housing 1, a forwarding socket 2, and a plurality of first power terminals 3. The mating connector M2′ includes a second insulative housing 4, a plurality of second power terminals 5, and a plurality of power wires 6. The similarities between the electrical connector assembly D′ (i.e., the forwarding connector M1′ and the mating connector M2′) of the second embodiment and the electrical connector assembly D (i.e., the forwarding connector M1 and the mating connector M2) of the first embodiment will not be reiterated herein. The main difference between the second embodiment and the first embodiment is that the structure of the first power terminals 3 and the second power terminals 5.

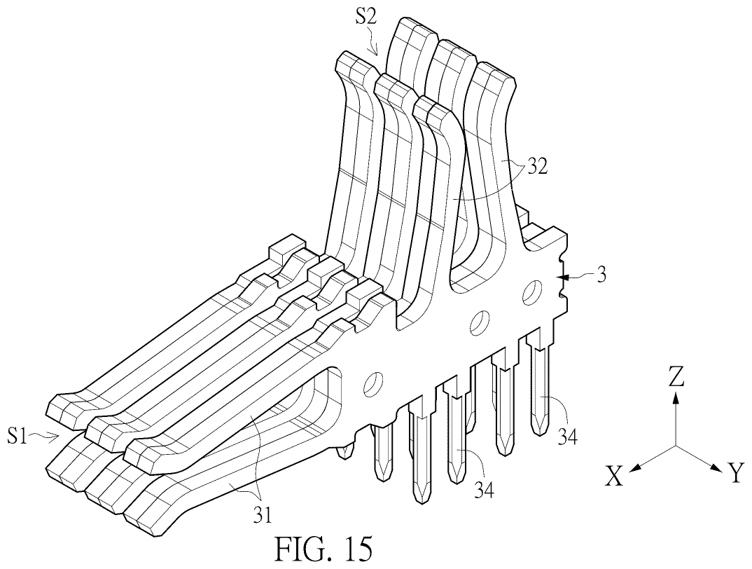

Reference is made to FIG. 15. In the second embodiment, each of first power terminals 3 is formed integrally. Each of the first power terminals 3 includes at least one first elastic arm 31, at least one first connecting arm 32, and at least one pin 34. The first connecting arm 32 and the pin 34 are arranged in a front-and-back configuration. The first elastic arm 31, the first connecting arm 32, and the pin 34 are located on a same plane (XZ plane), and the first elastic arm 31, the first connecting arm 32, and the pin 34 extend in different directions, respectively. In other embodiments, the first power terminals 3 cannot include the pins 34. That is, the first power terminals 3 have no physical contact with the circuit board B2, similar to the first embodiment.

As shown in FIG. 15, the plurality of first elastic arms 31 are paired off and oppositely arranged to form a plugging interface S1. The plurality of first power terminals 3 overlap with each other in a Y-axis direction, such that first contact portions 311 of the first elastic arms 31 are combined into a wider contact portion to increase the conductivity. Similarly, the plurality of first connecting arms 32 are paired off and oppositely arranged so as to form a plugging interface S2. The plurality of first power terminals 3 overlap with each other, such that the first connecting arms 32 are combined into another broader contact portion.

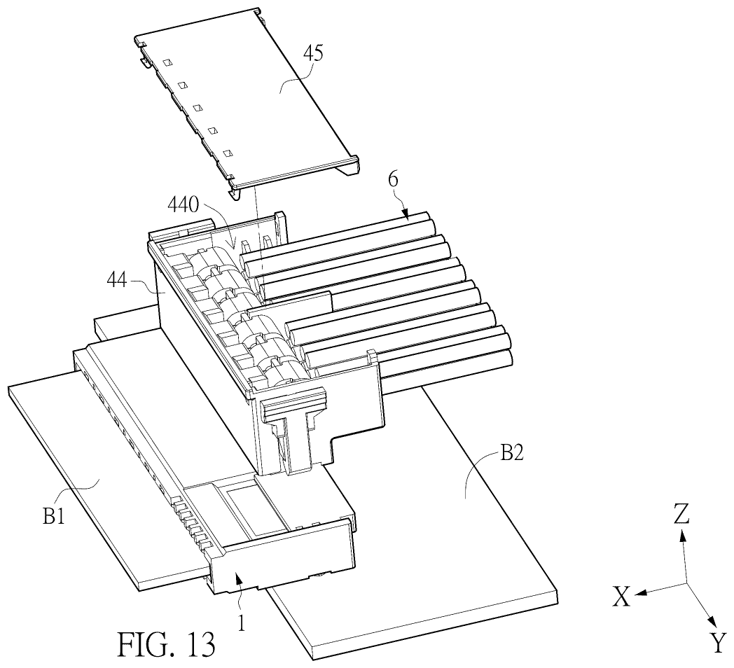

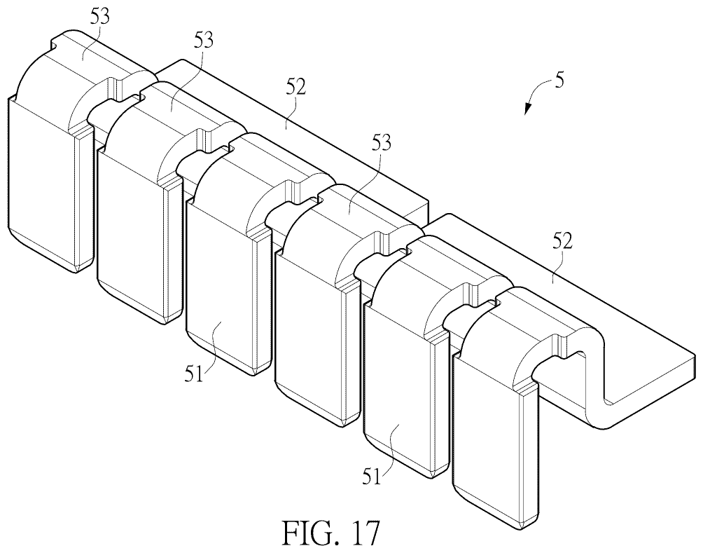

Reference is made to FIG. 17. Each of the second power terminals 5 is bent twice to form a U-shaped structure 53 that is located between a second contact arm 51 and a second connecting arm 52. The second contact arm 51 and the second connecting arm 52 are flat-shaped. The second insulative housing 4 includes a main body 44 and a cover 45. One side (e.g., an upper side) of the main body 44 has a slot 440. The second power terminals 5 are inserted into the second insulating housing 4 through the slot 440. As shown in FIGS. 13 and 17, the U-shaped structure 53 stably fixes the second power terminal 5 in the second insulating housing 4. Furthermore, the cover 45 covers the slot 440 of the main body 44 to complete the assembly. The plurality of power wires 6 extend out of the second insulating housing 4 through an outlet E defined by the cover 45 and the main body 44. Each of the second power terminals 5 is integrally formed and includes a plurality of second contact arms 51. In other words, one second connecting arm 52 can connect multiple second contact arms 51. Therefore, differences of the current transmitted and the heat energy generated by the plurality of second contact arms 51 can be balanced through the second connecting arm 52 to prevent the temperature of a single second contact arm 51 from being significantly higher than that of other second contact arms 51. Moreover, the cover 45 includes a plurality of through holes to dissipate heat.

As shown in FIGS. 12 and 14, the second insulative housing 4 includes two latching members 43. The two latching members 43 are disposed on two short sides of the second insulative housing 4. The forwarding socket 2 includes two protruding portions 21. The protruding portions 21 are disposed on two short sides of the forwarding socket 2. When the mating connector M2′ is plugged into the forwarding socket 2 of the forwarding connector M1′, two hook portions 432 of the two latching members 43 are snapped to the two protruding portions 21, respectively, so as to fix the mating connector M2′ with the forwarding connector M1′.

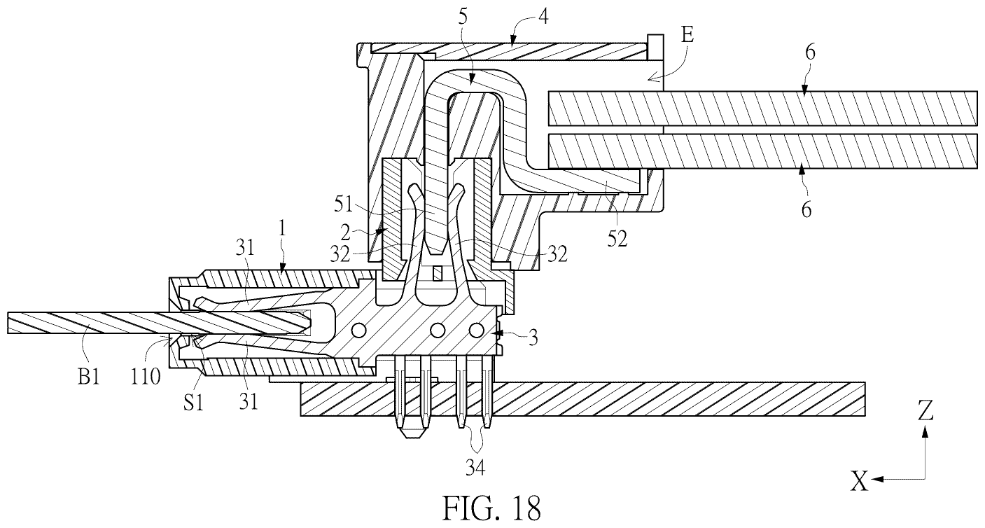

Reference is made to FIGS. 12, 15, and 18. When the mating connector M2′ is docked with the forwarding connector M1′, the second contact arms 51 are inserted into the plugging interface S2 and are electrically connected to the first connecting arms 32, and the first connecting arms 32 that are oppositely arranged to clamp the second contact arms 51. The second connecting arms 52 are electrically connected to the plurality of power wires 6. In addition, the electronic card B1 is inserted into a plugging interface S1 and electrically connected with the first elastic arms 31. The oppositely arranged first elastic arms 31 clamp the electronic card B1. The plurality of pins 34 are plugged into the circuit board B2. Therefore, the power provided by the electronic card B1 is shunted and transmitted to different paths. The power inputs from the electronic card B1. A part of the power passing through the first elastic arms 31 and the first connecting arms 32 and is transmitted to the power wires 6 through the second power terminals 5, while another part of the power is transmitted to the circuit board B2 through the first elastic arms 31 and the pins 34, so as to prevent large currents from flowing through the circuit board B2 and causing overheating. The signals are input from the electronic card B1 and transmitted to the circuit board B2 through the signal terminals.

### Beneficial Effects of the Embodiments

In the electrical connector assembly and the power system provided by the present disclosure, by virtue of “the first insulative housing 1 including a first lateral surface 11, a second lateral surface 12, and a third lateral surface 13 that face different orientations,” “the plurality of first elastic arms 31 being disposed in the first slot 110 to form an input interface F1,” and “the plurality of first connecting arms 32 extending from the second slot 130 and being disposed in the forwarding socket 2 to form a power output surface F2,” the input interface F1 and the power output interface F2 face different directions, thereby shunting power and signals provided by the electronic card B1 to different paths. Power is transmitted through the wire end connector that is mated with the socket of the connector, which prevents large currents from flowing through the circuit board B2 and causing overheating.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electrical connector assembly, comprising:
a forwarding connector mounted on a circuit board and including:
a first insulative housing including a first lateral surface and a second lateral surface that face different orientations, wherein the first lateral surface has a first slot;
a forwarding socket disposed on the second lateral surface; and
a plurality of first power terminals, wherein each of the first power terminals includes at least one first elastic arm and a first connecting arm, the first elastic arms of the plurality of first power terminals are disposed in the first slot to form an input interface for being inserted into by an electronic card that is used to provide power, and the first connecting arms of the plurality of first power terminals are disposed in the forwarding socket to form a power output surface;
wherein the plurality of first power terminals are not physically connected with the circuit board.

2. The electrical connector assembly according to claim 1, further comprising a mating connector adapted to the forwarding connector, wherein the mating connector is detachably plugged into the forwarding socket, and the mating connector includes a second insulative housing, a plurality of second power terminals, and a plurality of power wires; wherein the plurality of second power terminals are disposed in the second insulative housing, and the plurality of power wires are electrically connected to the plurality of second power terminals.

3. The electrical connector assembly according to claim 2, wherein the plurality of first power terminals are divided into a plurality of first terminal sets, each of the first terminal sets includes two of the first power terminals that are opposite to each other, the plurality of second power terminals are divided into a plurality of second terminal sets, and each of the second terminal sets includes two of the second power terminals that are opposite to each other.

4. The electrical connector assembly according to claim 3, wherein the first connecting arm is flat-shaped; wherein, when the electronic card is inserted into the first slot, the two first elastic arms of the two first power terminals of each of the first terminal sets clamp the electronic card.

5. The electrical connector assembly according to claim 4, wherein each of the second power terminals includes at least one second contact arm and a second connecting arm, the second connecting arm is flat-shaped; wherein, when the mating connector is plugged into the forwarding socket of the forwarding connector, the at least two second contact arms of the two second power terminals of each of the second terminal sets abut against the two first connecting arms of the two first power terminals of one of the first terminal sets, respectively.

6. The electrical connector assembly according to claim 5, wherein each of the first elastic arms includes a first contact portion, and the at least one second contact arm includes a second contact portion; wherein, in each of the first terminal sets, the two first contact portions of the two first power terminals are arranged to face each other; wherein, in each of the second terminal sets, the two second contact portions of the two second power terminals are arranged in a back-to-back configuration.

7. The electrical connector assembly according to claim 3, wherein the second insulative housing includes a partition wall and a stopping portion inside, the partition wall is disposed between the two second power terminals of each of the second terminal sets, and the stopping portion is connected to a bottom of the partition wall.

8. The electrical connector assembly according to claim 2, wherein each of the second power terminals includes at least one second contact arm and a second connecting arm, and a U-shaped structure is formed between the at least one second contact arm and the second connecting arm.

9. The electrical connector assembly according to claim 2, wherein the second insulative housing includes a main body and a cover, the plurality of power wires extend out of the second insulative housing through an outlet that is jointly defined by the cover and the main body.

10. The electrical connector assembly according to claim 2, wherein each of the second power terminals includes a plurality of second contact arms and a second connecting arm, each of the second contact arms is flat-shaped, and the second connecting arm is flat-shaped.

11. The electrical connector assembly according to claim 1, wherein the forwarding connector further includes a plurality of signal terminals and a third lateral surface, the third lateral surface has a second slot, each of the signal terminals includes an elastic arm and a pin; wherein the plurality of elastic arms of the signal terminals are disposed in the first slot, and the plurality of pins of the signal terminals extend out of the second slot and are inserted into the circuit board.

12. The electrical connector assembly according to claim 11, wherein a signal provided by the electronic card is input from the input interface and is completely transmitted to the circuit board through the plurality of signal terminals.

13. The electrical connector assembly according to claim 1, wherein the at least one first elastic arm and the first connecting arm of each of the first power terminals are coplanar, and the plurality of first power terminals are stacked with each other.

14. A power system, comprising:
a forwarding connector including:
a first insulative housing including a first lateral surface and a second lateral surface that face different orientations, wherein the first lateral surface has a first slot;
a forwarding socket disposed on the second lateral surface; and
a plurality of first power terminals, wherein each of the first power terminals includes a first elastic arm and a first connecting arm, the plurality of first elastic arms of the first power terminals are disposed in the first slot to form an input interface for being inserted into by an electronic card that is used to provide power, and the plurality of first connecting arms of the first power terminals are disposed in the forwarding socket to form a power output surface;
a mating connector adapted to the forwarding connector, wherein the mating connector is detachably plugged into the forwarding socket, and the mating connector includes:
a second insulative housing;
a plurality of second power terminals disposed in the second insulative housing; and
a plurality of power wires electrically connected to the plurality of second power terminals; and
a circuit board electrically connected to the plurality of power wires, wherein, when the electronic card is inserted into the input interface, currents provided by the electronic card are transmitted to the circuit board through the forwarding connector and the mating connector.

15. The power system according to claim 14, wherein the plurality of first power terminals are not physically connected with the circuit board.

16. The power system according to claim 14, wherein the plurality of first power terminals are divided into a plurality of first terminal sets, each of the first terminal sets includes two of the first power terminals that are opposite to and separated from each other.

17. The power system according to claim 16, wherein the plurality of second power terminals are divided into a plurality of second terminal sets, and each of the second terminal sets includes two of the second power terminals that are opposite to and separated from each other.

18. The power system according to claim 14, wherein the at least one first elastic arm and the first connecting arm of each of the first power terminals are coplanar, and the plurality of first power terminals are stacked with each other.
